(19) United States
(12) Patent Application Publication
(10) Pub. No.: US 2025/0244533 A1
(43) Pub. Date: Jul. 31, 2025

(54) ON-BOARD OPTICAL CONNECTION DEVICE

(71) Applicant: AIP Inc., New Taipei City (TW)

(72) Inventor: Chia LEE, New Taipei City (TW)

(21) Appl. No.: 19/000,859

(22) Filed: Dec. 24, 2024

Related U.S. Application Data
(63) Continuation-in-part of application No. 18/780,529, filed on Jul. 23, 2024.
(60) Provisional application No. 63/712,502, filed on Oct. 27, 2024.
(60) Provisional application No. 63/624,809, filed on Jan. 25, 2024.

(51) Int. Cl. G02B 6/28; G02B 6/43; H04B 10/40; H04B 10/80

(52) U.S. Cl. CPC G02B 6/28; G02B 6/43; H04B 10/40; H04B 10/802

(57) ABSTRACT

An on-board optical connection device, connected between a first data processing device and a second data processing device, includes an optical waveguide, a first signal transceiver, and a second signal transceiver. The optical waveguide is disposed between the first data processing device and the second data processing device. The first signal transceiver is optically coupled to the optical waveguide and converts an input electrical signal transmitted from the first data processing device to an optical signal. The second signal transceiver is optically coupled to the optical waveguide and converts the optical signal to an output electrical signal to the second data processing device.

### CROSS REFERENCE TO RELATED APPLICATIONS

This application claims the benefit of U.S. provisional patent application Ser. No. 63/712,502, filed Oct. 27, 2024, the entirety of which is incorporated by reference herein.

This application is a continuation-in-part of U.S. patent application Ser. No. 18/780,529, filed Jul. 23, 2024, which claims the priority of U.S. provisional patent application Ser. No. 63/624,809, filed Jan. 25, 2024, the entireties of which are incorporated by reference herein.

### BACKGROUND OF INVENTION

### 1. Field of Invention

The present invention relates to a technical field of optical connectors, and particularly to an on-board optical connection device used between two data processing devices.

### 2. Related Art

With the development of cloud technology and AI technology, high-speed transmission systems with higher and higher bandwidth will be needed in the future. Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and are generally co-packaged as co-packaged optics (CPO). Based on OEICs, the use of optical communication can greatly improve the performance of graphical processing units or central processing units. In order to meet the explosive demand for computing speed, the use of multiple processors in a single system has become a development trend. However, there is still no better solution for optical interconnection between multi-processor architectures. Although active optical cables may be used for the interconnection, they are susceptible to optical fiber damage and not conducive to internal space management.

### SUMMARY OF INVENTION

An object of the present application is to provide an on-board optical connection device connected between two data processing devices for electrical-optical signal and optical-electrical signal transmission without the use of optical fiber cables.

Another object of the present application is to provide an on-board optical connection device capable of reducing waveguide propagation loss when connecting two data processing devices.

To achieve the above-mentioned objects, one aspect of the present application is to provide an on-board optical connection device, connected between a first data processing device and a second data processing device, and the on-board optical connection device includes an optical waveguide disposed between the first data processing device and the second data processing device, a first signal transceiver optically coupled to the optical waveguide and converting an input electrical signal transmitted from the first data processing device to an optical signal, and a second signal transceiver optically coupled to the optical waveguide and converting the optical signal to an output electrical signal to the second data processing device.

Optionally, the on-board optical connection device further includes a load board. The optical waveguide, the first signal transceiver, and the second signal transceiver are disposed on the load board.

Optionally, the first signal transceiver includes a signal input module including a bar substrate, a plurality of light emitters, and a plurality of conductive components electrically connected between the signal input module and the first data processing device. Each of the light emitters is concurrently integrally arranged on the bar substrate and is configured to transmit the optical signal to the optical waveguide.

Optionally, the bar substrate is configured to cross a bottom of each of the light emitters, the plurality of light emitters are adjustable in position in conjunction with the bar substrate, and the light emitters are concurrently optically aligned with the waveguide device through a one-time active alignment process.

Optionally, the second signal transceiver includes a signal output module including a supporting substrate, a plurality of light receptors arranged on the supporting substrate, and a plurality of second conductive components electrically connected between the signal output module and the second data processing device. The light receptors receive the optical signal and convert the optical signal to the output electrical signal.

Optionally, the optical waveguide includes a waveguide substrate and a plurality of light paths disposed on the waveguide substrate, which is made of a material including silica, silicon, or silicon nitride.

Optionally, the light paths of the optical waveguide are configured to define a planar lightwave circuit.

Optionally, the waveguide substrate includes a reflection structure located close to the signal output module and angularly disposed with respect to the light paths, and the optical signal transmitted from the signal input module is reflected by the reflection structure and strikes the signal output module.

Optionally, the optical waveguide further includes at least an optical isolator arranged across the light paths, and the optical isolator is configured to enable light transmission through the light paths in a desired direction to the signal output module.

Optionally, the optical waveguide further includes at least a slot and a plurality of light directing structures, the slot is arranged across the light paths, the light directing structures are located at opposite sides of the slot and adjoin the respective light paths, and the optical isolator is disposed in the slot and facing the light directing structures. Each of the light directing structures expands from the light path such that the light directing structure forms an aperture greater than a diameter of the light path.

To achieve the above-mentioned objects, another aspect of the present application is to provide an on-board optical connection device, connected between a first data processing device and a second data processing device, the on-board optical connection device including a load board, an optical waveguide disposed on the load board and including a waveguide substrate and a plurality of light paths disposed on the waveguide substrate, a first signal transceiver optically connected to the optical waveguide and disposed between the optical waveguide and the first data processing device on the load board, and a second signal transceiver optically connected to the optical waveguide and disposed between the optical waveguide and the second data processing device on the load board. Each of the first signal transceiver and the second signal transceiver defines a light input area and a light output area, and the two light input areas and the two light output areas cooperatively define a signal route.

Optionally, the first signal transceiver and the second signal transceiver are connected to a first external power device and a second external power device, respectively.

Optionally, the first signal transceiver includes a plurality of light emitters disposed in the light input area of the first signal transceiver, and the second signal transceiver includes a plurality of light emitters disposed in the light input area of the second signal transceiver. The light emitters are arranged in optical alignment with the light paths, respectively.

Optionally, the first signal transceiver includes a plurality of optical channels disposed in the light output area of the first signal transceiver, and the second signal transceiver includes a plurality of optical channels disposed in the light output area of the second signal transceiver. The optical channels in the light output areas are in optical alignment with the light paths, respectively.

In the present application, the on-board optical connection device which can be sized to connect the first data processing device and the second data processing device for electrical-optical signal and optical-electrical signal transmission or for all optical signal transmission without the use of optical fiber cables, which is conducive to internal space management. In addition, the integral formation of the light emitters on the bar substrate makes the optical alignment with the waveguide device less time-consuming. Furthermore, the disposition of the optical isolator and the light directing structures reduces optical signal transmission loss, thereby solving the problem of optical fiber damage, waveguide propagation loss, and less efficient internal space arrangement when connecting two data processing devices

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1A is a schematic perspective view of an on-board optical connection device in accordance with an embodiment of the present application.

FIG. 1B is a schematic side view of FIG. 1.

FIG. 2A is a schematic perspective view of an on-board optical connection device in accordance with an embodiment of the present application.

FIG. 2B is a side view of FIG. 2A.

FIG. 3 is a schematic cross-sectional view showing a signal input module in accordance with an embodiment of the present application.

FIG. 4 is a schematic perspective view showing an on-board optical connection device connected between first and second data processing devices.

FIG. 5A is an enlarged view of an optical waveguide in accordance with an embodiment of the present application.

FIG. 5B is a schematic side view showing an edge surface of the optical waveguide of FIG. 5A.

FIG. 6 is a partially enlarged view of an optical waveguide in accordance with an embodiment of the present application.

FIG. 6A is a schematic partially enlarged view of an optical isolator in accordance with an embodiment of the present application.

FIG. 6B is a schematic structural view illustrating a working principle of an optical isolator in accordance with an embodiment of the present application.

FIG. 7 is a schematic side view of an on-board optical connection device in accordance with an embodiment of the present application.

FIG. 8 is a schematic side view of an on-board optical connection device in accordance with an embodiment of the present application.

FIG. 9 is a schematic side view of an on-board optical connection device in accordance with an embodiment of the present application.

FIG. 10A is a schematic side view showing a mounting structure used between the on-board optical connection device of FIG. 8 and two data processing devices.

FIG. 10B is a partially enlarged perspective view of the mounting structure shown in FIG. 10A.

FIG. 11A is a schematic structural view showing a working principle of a type of laser element disposed in an on-board optical connection device in accordance with an embodiment of the present application.

FIG. 11B is a schematic structural view showing a working principle of another type of laser element disposed in an on-board optical connection device in accordance with an embodiment of the present application.

FIG. 11C is a schematic structural view showing a working principle of another type of laser element disposed in an on-board optical connection device in accordance with an embodiment of the present application.

FIG. 12 is a schematic perspective view of an on-board optical connection device connected between two data processing devices in accordance with an embodiment of the present application.

FIG. 13 is a schematic perspective view of an on-board optical connection device connected between two data processing devices in accordance with an embodiment of the present application.

FIG. 14 is a schematic perspective view of an on-board optical connection device connected between two data processing devices in accordance with an embodiment of the present application.

FIG. 15 is a cross-sectional view of a packaged on-board optical connection device in accordance with an embodiment of the present application.

FIG. 16 is a schematic top structural view of the packaged on-board optical connection device shown in FIG. 15.

FIG. 17 is a schematic perspective view showing a packaged on-board optical connection device connected between two data processing devices in accordance with an embodiment of the present application.

FIG. 18 is a schematic perspective view showing an on-board optical connection device in accordance with another embodiment of the present application.

FIG. 19 is a schematic top plan view of FIG. 18 in which an external power device is provided.

### DESCRIPTION OF PREFERRED EMBODIMENTS

The following embodiments are referring to the appendix drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application. In addition, the present application may repeat reference numerals and/or letters in the various examples. This repetition is for the purpose of simplicity and clarity and does not in itself dictate a relationship between the various embodiments and/or configurations discussed.

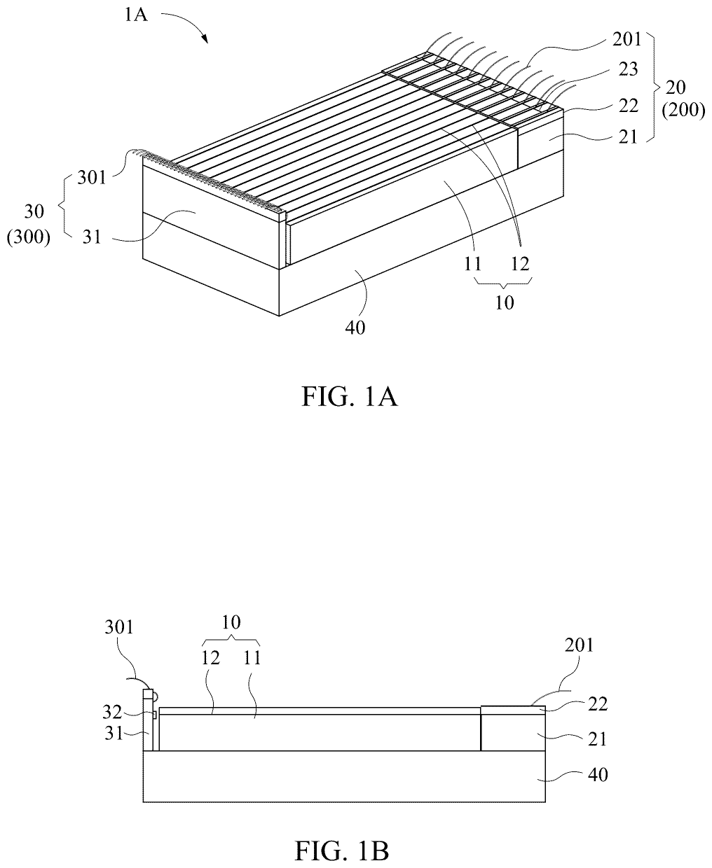

In one aspect, the present application provides an on-board optical connection device used between two data processing devices for electrical-optical signal and optical-electrical signal transmission. In some embodiments, the data processing devices may be graphics processing units, central processing units, neural network processing units, etc. Referring to FIGS. 1A and 1B, FIG. 1A is a schematic perspective view of an on-board optical connection device in accordance with an embodiment of the present application, and FIG. 1B is a schematic side view of FIG. 1. The present application provides an on-board optical connection device 1A including an optical waveguide 10, a first signal transceiver 200, a second signal transceiver 300, and a load board 40 supporting the optical waveguide 10, the first signal transceiver 200, and the second signal transceiver 300. Specifically, the optical waveguide 10 is disposed between the first signal transceiver 200 and the second signal transceiver 300 and includes a waveguide substrate 11 and a plurality of light paths 12 formed thereon. In some embodiments, the waveguide substrate 11 may be made of silica, silicon, or silicon nitride. The light paths 12 are arranged to form a planar lightwave circuit (PLC), which may be configured in various ways, including, but not limited to, a straight line circuit, a splitter circuit, an arrayed waveguide grating wavelength multiplexer, and a cross connect-type circuit. Preferably, the waveguide substrate 11 is made of silica.

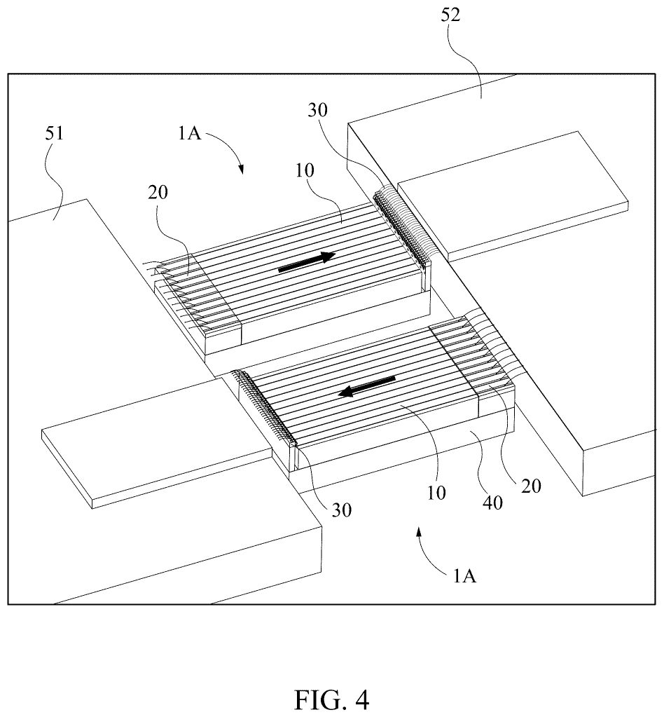

As shown in FIG. 1A, the first signal transceiver 200 includes at least one signal input module 20, which is optically connected to one end of the optical waveguide 10 to convert input electrical signals transmitted from a first data processing device 51 (as shown in FIG. 4, which will be described later) to optical signals. In detail, the signal input module 20 includes a bar substrate 21, a plurality of light emitters 22 arranged in an array, and a plurality of first conductive components 201. The light emitters 22 may be edge emitting laser diodes, surface emitting laser diodes, vertical cavity surface emitting laser (VCSEL) diodes, or distributed feedback (DFB) laser diodes, which will not be limited herein. The first conductive components 201 are configured to electrically connect the signal input module 20 to the first data processing device 51. Preferably, the light emitters 22 are DFB laser diodes, but are not limited thereto.

Still referring to FIG. 1A, the second signal transceiver 300 includes at least one signal output module 30, which is optically connected to another end of the optical waveguide 10 opposite to the signal input module 20. The signal output module 30 is provided to convert the optical signals to an output electrical signal to a second data processing device 52 (as shown in FIG. 4, which will be described later). In detail, the signal output module 30 includes a supporting substrate 31, a plurality of light receptors 32 (as shown in FIG. 1B) arranged in an array on the supporting substrate 31, and a plurality of second conductive components 301 configured to electrically connect the light receptors 32 to a driving circuit (not shown) disposed on the second data processing device 52. In some embodiments, the light receptors 32 may be photodiodes.

Referring to FIGS. 1A and 1B, the light emitters 22, in response to the input electrical signals received by the signal input module 20, emit light to travel straight forward to the light paths 12 of the optical waveguide 10. In this embodiment, the light receptors 32 are coplanar with the light paths 12 so that the light travelling along the light paths 12 from the light emitters 22 strikes the light receptors 32 in the straight forward direction. The light receptors 32 convert the optical signals to the output electrical signals, which are transmitted to the second data processing device 52 through the second conductive components 301.

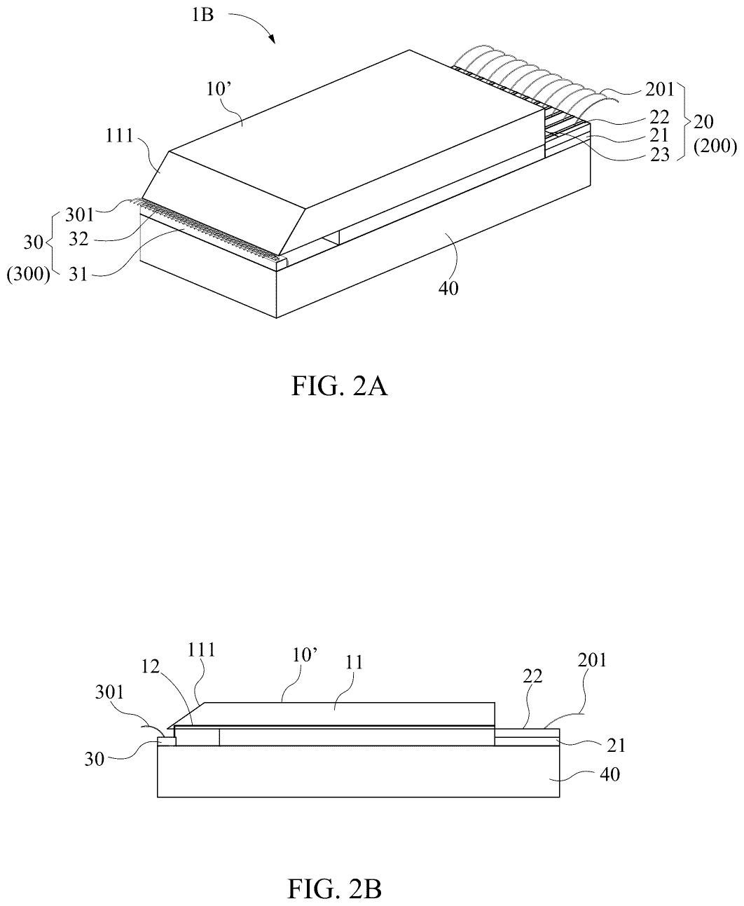

Referring to FIGS. 2A and 2B, showing an on-board optical connection device 1B in accordance with another embodiment of the present application, the on-board optical connection device 1B includes an optical waveguide 10′, a first signal transceiver 200 including at least one signal input module 20, a second signal transceiver 300 including at least one signal output module 30, and a load board 40. The on-board optical connection device 1B and the on-board optical connection device 1A are substantially the same in structure except for the optical waveguide and an orientation of the signal output module 30. Specifically, in the embodiment shown in FIG. 2B, the optical waveguide 10′ includes a waveguide substrate 11, a plurality of light paths 12 formed in the waveguide substrate 11, and a reflection structure 111 located close to the signal output module 30 and angularly disposed with respect to the light paths 12.

Referring to FIGS. 2A and 2B, in some embodiments, the reflection structure 111 is an oblique wall configured to direct light beams travelling along the light paths 12 from the signal input module 20 to the signal output module 30. Specifically, the light beams are reflected by the oblique wall to be deflected downward to the light receptors 32. In some embodiments, the reflection structure 111 may be coated with a reflection layer (not shown) so that the light beams are being reflected by the reflection layer to strike the light receptors 32.

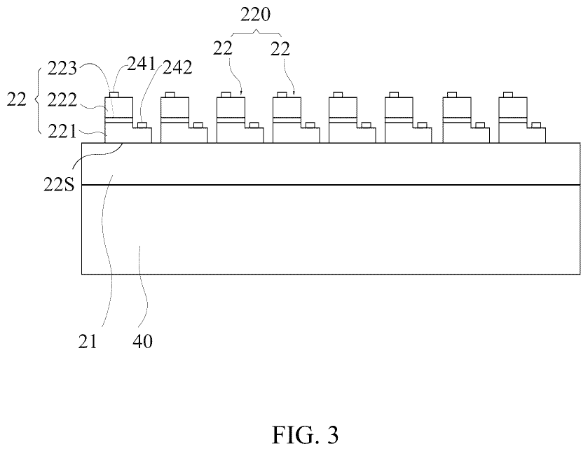

Referring to FIG. 3, which is a schematic cross-sectional view showing the signal input module 20 of the present application, in some embodiments, a light unit 220 (referred to as the collection of the light emitters 22 or a light emitter array) is fabricated via semiconductor fabrication process such as epitaxy on the bar substrate 21 at the same time. Specifically, the light unit 220 and the bar substrate 21 are fabricated by thin film growth processes, lithography, doping processes, and etching processes. The light unit 220, after undergoing the film growth processes, etc., are disposed on the bar substrate 21 and are further divided into the plurality of light emitters 22 through the etching processes such that the plurality of light emitters 22 are spaced apart from each other and arranged in alignment with each other.

As shown in FIG. 3, the light unit 220 includes a functional portion including an N-type semiconductor structure 221 and a P-type semiconductor structure 222, and a light-emitting portion 223. The light-emitting portion 223, made of a semiconductor material, such as gallium arsenide (GaAs), is disposed between the N-type semiconductor structure 221 and the P-type semiconductor structure 222. Each of the light emitters 22 includes an anode 241 and a cathode 242 that are formed on the P-type semiconductor structure 222 and the N-type semiconductor structure 221, respectively. In some embodiments, the light emitters 22 are laser emitters, for example, such as gallium arsenide (GaAs) laser diodes, gallium nitride (GaN) laser diodes, or indium gallium arsenide phosphide (InGaAsP) laser diodes, but are not limited thereto. In this embodiment, the bar substrate 21 is configured to cross a bottom of each of the light emitters 22.

Still referring to FIG. 3, in this embodiment, the light emitters 22 need to be epitaxially grown first, that is, N-type semiconductors 221, P-type semiconductors 222, and light-emitting portion 223 are grown on the bar substrate 21, such that each of the light emitters 22 has an epitaxial layer 22S on the bar substrate 21, and the light emitters 22 are concurrently integrally formed on the bar substrate 21. Taking gallium nitride laser diodes as an example. GaN laser diodes are grown on sapphire substrates. A growth method can be metal organic chemical-vapor deposition (MOCVD). In detail, as shown in FIG. 3, after all layers of the light emitters 22 are formed in turn on the bar substrate 21 as an entire surface to include all the light emitters 22, an etching process is performed to divide the layers except the sapphire substrate so formed into a plurality of units of the light emitters 22. Then, use a dry etching method to dig out part of a surface of the P-type semiconductor 222 of each light emitter 22 to expose the N-type semiconductor structure 221 underneath, and then provide the anode 241 and the cathode 242 on the P-type and N-type semiconductors 222 and 221 (as well as a driving circuit 23 on the bar substrate 21 as shown in FIG. 1A) so that current can pass through and emit light. It should be noted that the method of fabricating the light emitters 22 is not limited thereto.

In doing so, there is no need to perform die sawing (as known as dicing) and binning processes, and the light emitters 22 are adjustable in position in conjunction with the bar substrate 21, so that the light emitters 22 in the light emitter array can be optically aligned at one time with the light paths 12 of the optical waveguide 10, thus ensuring precise and efficient optical alignment.

Referring to FIG. 1A and FIG. 3, the bar substrate 21 includes the driving circuit 23 coupling with the anode 241 and the cathode 242 of each of the light emitters 22 and configured to provide a driving voltage or driving current to the light emitters 22 as well as providing the power as required to the light emitters 22. In some embodiments, the bar substrate 21 has the characteristics of high temperature resistance, corrosion resistance, high hardness, and high melting point. Preferably, the bar substrate 21 is a sapphire substrate or gallium arsenide (GaAs) substrate depending on types of the light emitters 22.

Referring to FIG. 4, two on-board optical connection devices 1A are connected between the first data processing device 51 and the second data processing device 52. One of the on-board optical connection devices 1A serves to allow electrical signals to be transmitted from the first data processing device 51 to the second data processing device 52, and the other one of the on-board optical connection devices 1A serves to enable electrical signal transmission from the second data processing device 52 to the first data processing device 51, so that signal routes are created by the two separated on-board optical connection devices 1A between the first data processing device 51 and the second data processing device 52.

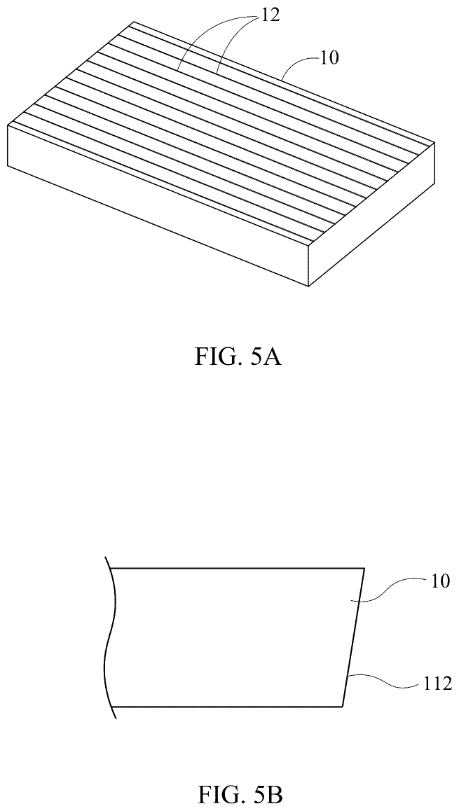

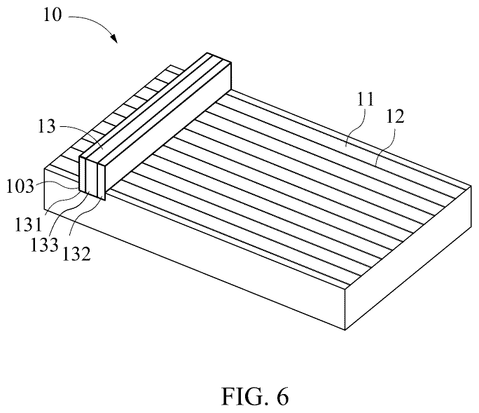

Referring to FIG. 5A, which is an enlarged view of an optical waveguide 10 in accordance with an embodiment of the present application, the optical waveguide 10 is configured to have straightforward light paths 12. Referring to FIG. 5B, which is a schematic side view showing an edge surface of the optical waveguide 10 of FIG. 5A, the optical waveguide 10 is configured to have a guide surface 112 facing the signal input module 20 and/or the signal output module 30. The guide surface 112 tilts at a predetermined tilt angle with respect to the signal input module 20 or the signal output module 30 so that the light paths 12 are in angled physical contact with the signal input module 20 and/or the signal output module 30, thereby ensuring the light travelling along the light paths 12 can precisely propagate into the respective light emitters 22 or the light receptors 32 and reduce interference caused by reflected light. The predetermined tilt angle is between zero and eight degrees, preferably eight degrees. In some embodiments, the guide surface 112 may be coated with an anti-reflection layer to reduce light reflection, thus reducing the optical signal transmission loss.

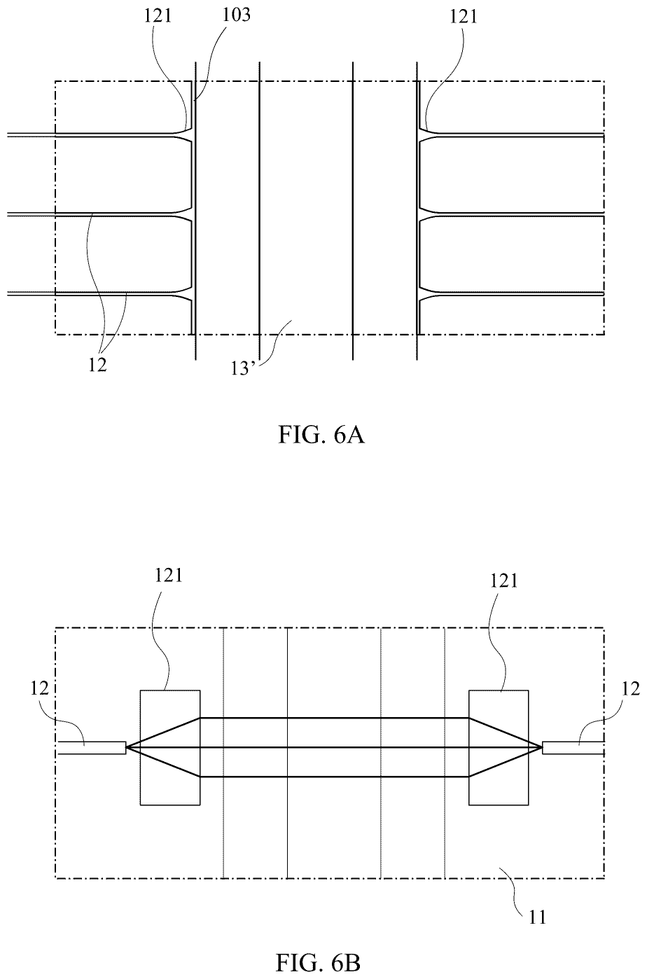

Referring to FIG. 6, which is a partially enlarged view of an optical waveguide in accordance with an embodiment of the present application, an optical isolator 13 is further disposed on the optical waveguide 10. As shown in FIG. 6, a slot 103 is formed on the waveguide substrate 11 and arranged across the light paths 12. In some embodiments, the optical isolator 13 is separately provided and is inserted in the slot 103. Specifically, the optical isolator 13 is separately prepared from the optical waveguide 10 and mainly includes an input polarization element 131, an output polarization element 132, and an optical rotator 133 disposed between the input polarization element 131 and the output polarization element 132. The optical isolator 13 is configured to use polarization rotation to block return light signals from the forward optical path. Since the working principle of the optical isolator 13 is known to those skilled in the art, it will not be described in detail here. Specifically, the optical isolator 13 is configured to enable the light from the light paths 12 to propagate in a desired direction to the signal input module 20 and the signal output module 30 and reduce interference caused by reflected light, thereby exhibiting a relatively low propagation loss in the desired direction.

In some embodiments, the optical isolator 13 may be integrally formed on the optical waveguide 10 through semiconductor fabrication processes, such as epitaxial growth processes, photolithography, and etching processes, during the formation of the optical waveguide 10, so that the optical isolator 13 and the optical waveguide 10 are formed together as an one-piece element. In some embodiment, opposite surfaces of the slot 103 adjoining the optical isolator 13 may be coated with anti-reflection layers.

Referring to FIG. 6A, which is a schematic partially enlarged view of an optical isolator 13′ in accordance with an embodiment of the present application, in this embodiment, a separate optical isolator 13′ is disposed in the slot 103 at where the light paths 12 are going through. Specifically, the optical waveguide 10 further includes a plurality of light directing structures 121 located at opposite side portions of the slot 103. The light directing structures 121 are integrally formed with the light paths 12 through semiconductor fabrication processes, such as photolithography and etching processes.

As shown in FIG. 6A, there are two light directing structures 121 formed as a set and located at a opposite side portions of the slot 103, and the opposite sets of the light directing structures 121 are located in alignment with each other and adjoin the respective light paths 12. The optical isolator 13′ is disposed in the slot 103 and faces the light directing structures 121. In detail, each set of the light directing structures 121 expands from the light path 12 in such a way that the light directing structures 121 form an aperture greater than a diameter of the light path 12. Preferably, the light directing structure 121 tilts at eight degrees with respect to the light path 12. In doing so, in the event that the light is reflected when travelling between the signal input module 20 and the signal output module 30, it will be reflected back by the light directing structure 121 and go in the desired direction to the light paths 12. Therefore, the optical isolator 13′ and the light directing structures 121 jointly ensure light propagation in one desired direction to the signal output module 30, thereby reducing the optical signal transmission loss.

Referring to FIG. 6B illustrating the working principle of the light directing structure 121, the two light directing structures 121 may be equivalent to two lenses configured on the opposite surfaces of the optical isolator to allow the light from the light path 12 to be reflected in a desired direction so that the light can be completely received by the signal input module 20 or the signal output module 30.

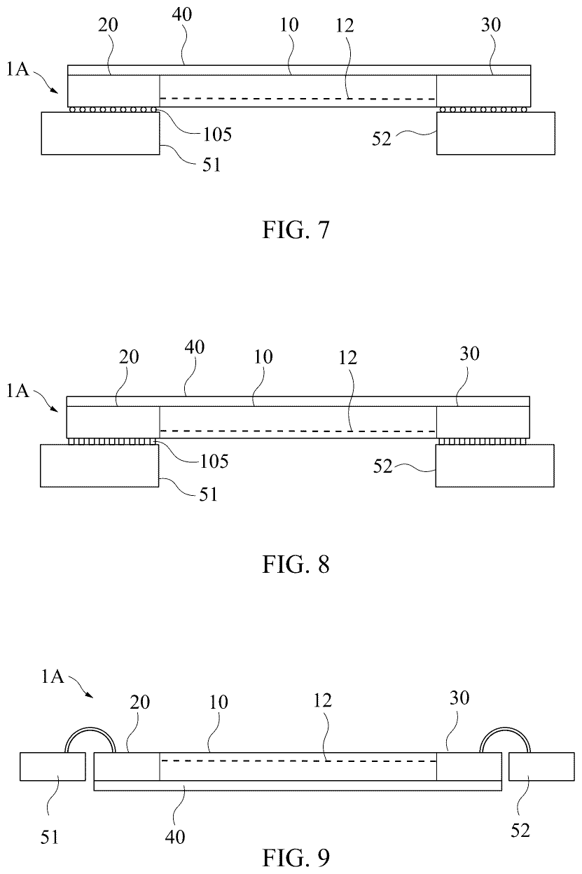

Referring to FIGS. 7 and 8 showing various types of bonding between the on-board optical connection device 1A and the first data processing device 51 and the second data processing device 52, in these embodiments, the waveguide substare 10, the signal input module 20, and the signal output module 30 are made of a silicon-based material, so that the signal input module 20 and the signal output module 30 can be configured in direct electrical contact with the first data processing device 51 and the second data processing device 52, respectively, thereby reducing the signal transmission distance and improving data processing efficiency. As shown in FIG. 7, the on-board optical connection device 1A is electrically mounted on the first and the second data processing devices 51 and 52 through flip-chip bonding technologies. Referring to FIG. 8, the on-board optical connection device 1A is electrically mounted on the first and the second data processing devices 51 and 52 through electrically conductive pillars 105.

Referring to FIG. 9, showing another type of bonding between the on-board optical connection device 1A and the first data processing device 51 and the second data processing device 52, the on-board optical connection device 1A is connected to the first and the second data processing devices 51 and 52 through wire bonding. In some embodiments, an external power (not shown) may be provided to connect with the signal input module 20 for the supply of necessary power.

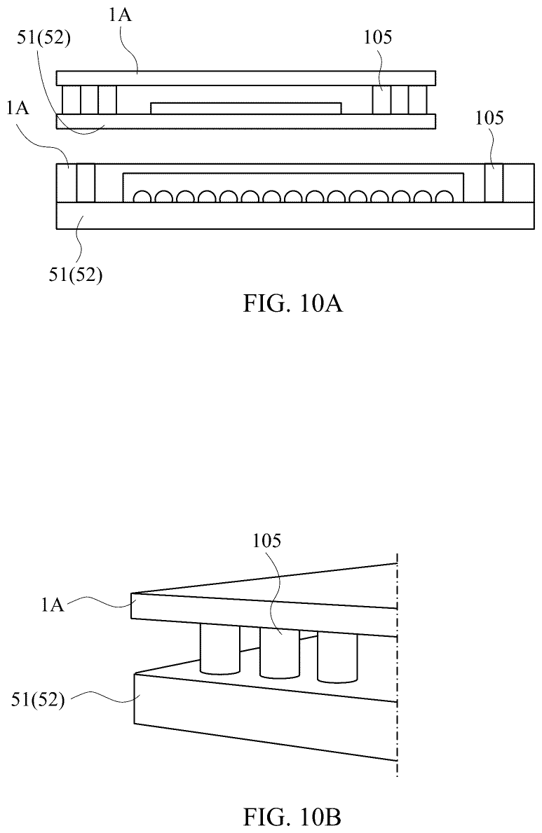

Referring to FIGS. 10A and 10B, the electrically conductive pillars 105 may be made of copper or copper alloy, but not limited thereto. FIG. 10A shows a package on package (PoP) encapsulation and a fan-out wafer level packaging (FOWLP) of the on-board optical connection device 1A. The electrically conductive pillars 105 are arranged between the on-board optical connection device 1A and the first and the second data processing devices 51 and 52 such that the on-board optical connection device 1A is stacked on the first and the second data processing devices 51 and 52.

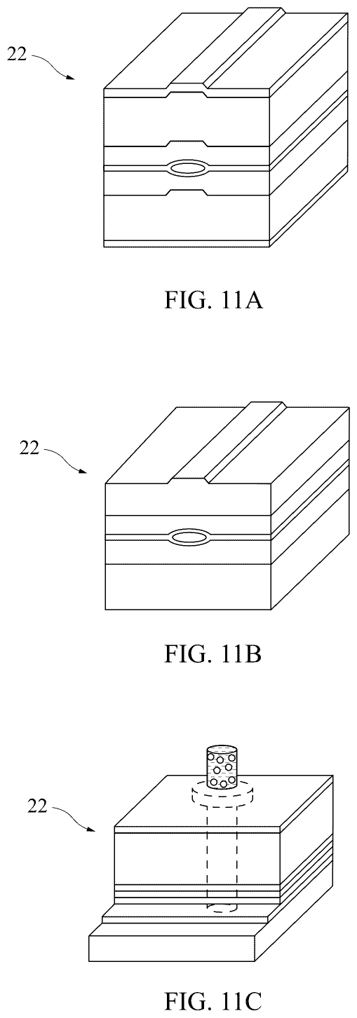

Referring to FIGS. 11A to 11C, they are schematic structural views showing working principle of various types of the light emitters 22 disposed in the on-board optical connection device in accordance with embodiments of the present application. As shown in FIG. 11A, the light emitters 22 in the light emitter array may be Fabry-Perot (FP) laser diodes. As shown in FIG. 11B, the light emitter array may be DFB laser diodes. As shown in FIG. 11C, the light emitter array may be VCSEL laser diodes. It should be noted that since the specific structures of the above-mentioned laser diodes are known to those skilled in the art, they are not described in detail here.

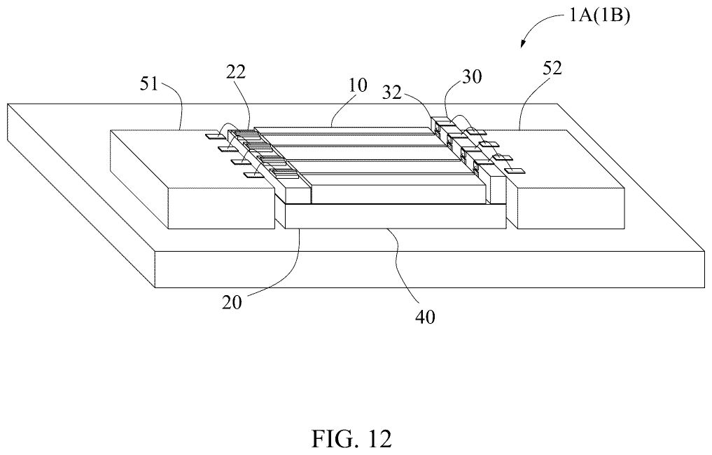

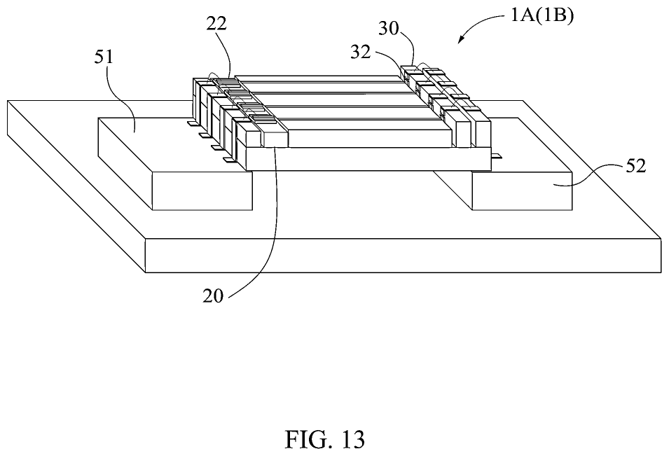

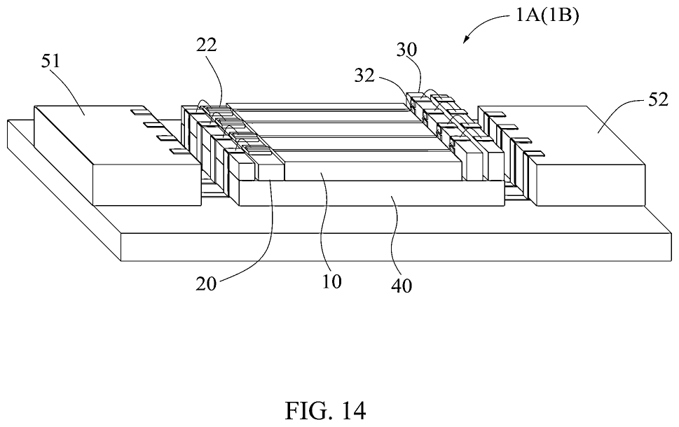

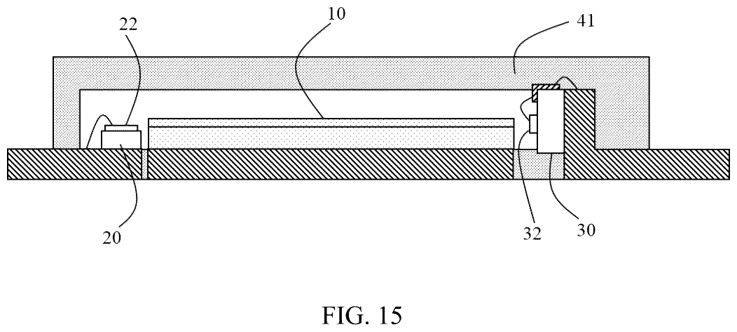

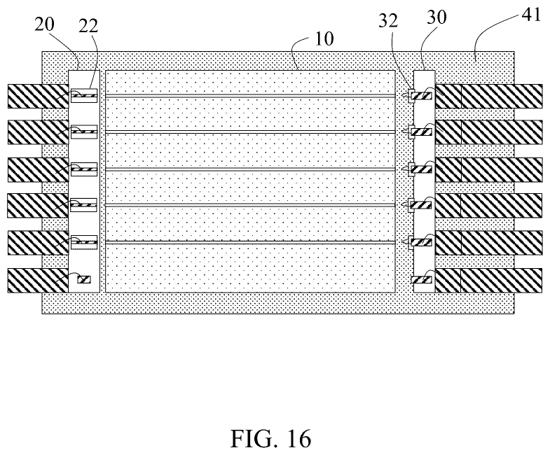

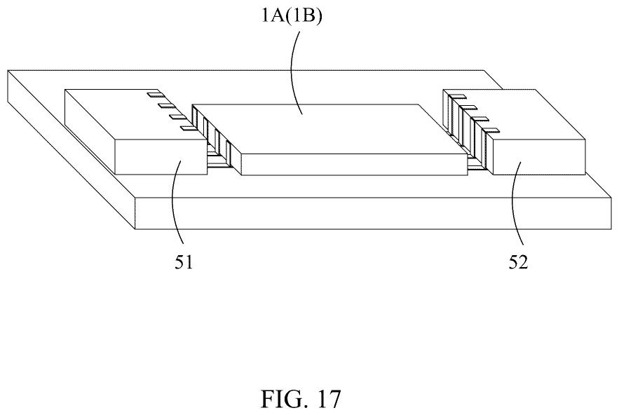

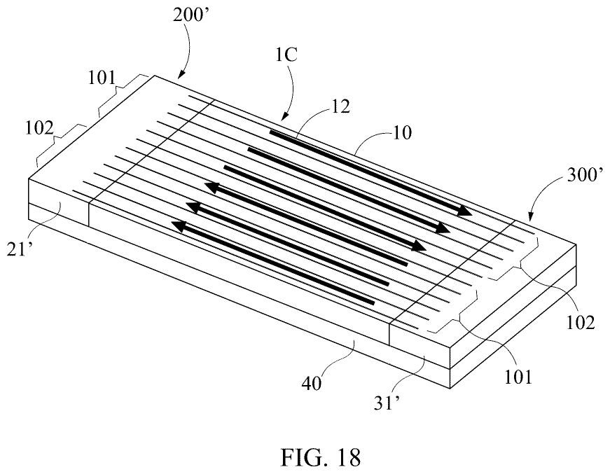

Referring to FIGS. 12 to 17, they schematically show various types of bonding between the on-board optical connection device 1A (1B) and the first data processing device 51 and the second data processing device 52. Specifically, FIGS. 15 and 16 show an encapsulation layer 41 is formed to encapsule and protect the optical waveguide 10, the signal input module 20, and the signal output module 30. In some embodiments, the encapsulation layer 41 may be made of a resin-based material and may be cured by ultra-violet radiation.

Referring to FIG. 18, in another aspect, the present application provides an on-board optical connection device 1C. It should be noted that the first data processing device 51 and the second data processing device 52 are not shown in this embodiment for clarity. As shown in FIG. 18, the on-board optical connection device 1C includes an optical waveguide 10, a first signal transceiver 200′, a second signal transceiver 300′, and a load board 40. Specifically, the first signal transceiver 200′ and the second signal transceiver 300′ are optically connected to the optical waveguide 10 on the load board 40. In some embodiments, each of the first signal transceiver 200′ and the second signal transceiver 300′ is divided into a light input area 101 and a light output area 102 on opposite sides of the optical waveguide 10. It is noted that certain components are not shown in FIG. 18 for clarity of presentation of the light input areas 101 and the light output areas 102.

As shown in FIG. 18, the optical signal transmission starts from the light input area 101 on the side of the first signal transceiver 200′ to pass the light paths 12 of the optical waveguide 10 in a forward direction and then reach the light output area 102 on the side of second signal transceiver 300′ so as to create a signal route. Likewise, another signal route starts from the light input area 101 on the side of the second signal transceiver 300′ to pass the light paths 12 in a direction opposite to the forward direction to reach the light output area 102 on the side of the first signal transceiver 200′. That is, the two light input areas 101 and the two light output areas 102 on opposite sides of the optical waveguide 10 form a joint signal path on the same load board 40, which is conducive to the area reduction in terms of the arrangement of the first data processing device 51 and the second data processing device 52.

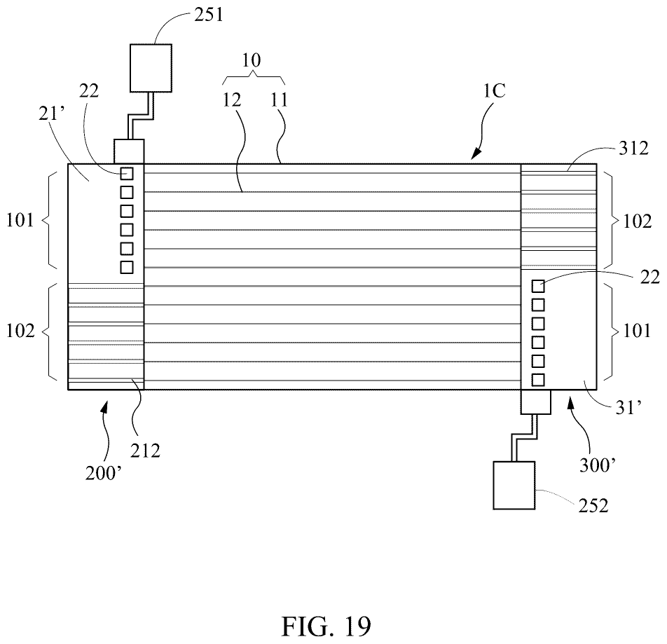

Referring to FIG. 19, which is a schematic top plan view of FIG. 18, in some embodiments, the first signal transceiver 200′ includes a plurality of light emitters 22 disposed in the light input area 101 of the first signal transceiver 200′, and the second signal transceiver 300′ includes a plurality of light emitters 22 disposed in the light input area 101 of the second signal transceiver 300′. The light emitters 22 are arranged in optical alignment with the light paths 12, respectively. As shown in FIG. 19, the first signal transceiver 200′ includes a bar substrate 21′ and a plurality of optical channels 212 disposed in the light output area 102 on the bar substrate 21′, and the second signal transceiver 300′ includes a supporting substrate 31′ and a plurality of optical channels 312 disposed in the light output area 102 on the supporting substrate 31′. The optical channels 212 and 312 in the light output areas 102 are in optical alignment with the light paths, respectively.

Still referring to FIG. 19, in this embodiment, the light emitters 22 and the optical channels 212 and 312 of the first signal transceiver 200′ and the second signal transceiver 300′ may be formed by the semiconductor fabrication processes, such as epitaxial growth processes, photolithography, and etching processes. Specifically, the light emitters 22 may be fabricated through the same method as described in the above-mentioned embodiments. That is, the light emitters 22 of the first signal transceiver 200′ are concurrently and integrally formed on the bar substrate 21′ in conjunction with the formation of the optical channels 212 through the semiconductor fabrication processes. Likewise, the light emitters 22 of the second signal transceiver 300′ are concurrently and integrally formed on the supporting substrate 31′ in conjunction with the formation of the optical channels 312. In this embodiment, the first signal transceiver 200′ and the second signal transceiver 300′ are connected to a first external power device 251 and a second external power device 252 for the supply of necessary power, respectively. Since the optical channels 212 and 312 function to optically connect with the first data processing device 51 and the second data processing device 52 and the use of the first external power device 251 and the second external power device 252, no photodiodes (light receptors) and no conductive components are needed for electrical connection with the first data processing device 51 and the second data processing device 52, thereby achieving all optical transmission between the on-board optical connection device 1C and the first data processing device 51 and the second data processing device 52.

Similarly, the on-board optical connection device 1C may include the optical isolator 13, 13′ and the light directing structures 121 to reduce optical signal transmission loss. For the structure and disposition of the optical isolator 13, 13′ and the light directing structures 121 please refer to the description of the first aspect, and details are not repeated here.

Accordingly, the present application provides the on-board optical connection device which can be sized to connect the first data processing device and the second data processing device for electrical-optical signal and optical-electrical signal transmission or for all optical signal transmission without the use of optical fiber cables, which is conducive to internal space management. In addition, the integral formation of the light emitters on the bar substrate makes the optical alignment with the waveguide device less time-consuming. Furthermore, the disposition of the optical isolator and the light directing structures reduces optical signal transmission loss, thereby solving the problem of optical fiber damage, waveguide propagation loss, and less efficient internal space arrangement when connecting two data processing devices.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An on-board optical connection device, connected between a first data processing device and a second data processing device, the on-board optical connection device comprising:
an optical waveguide disposed between the first data processing device and the second data processing device;
a first signal transceiver optically coupled to the optical waveguide and converting an input electrical signal transmitted from the first data processing device to an optical signal; and
a second signal transceiver optically coupled to the optical waveguide and converting the optical signal to an output electrical signal to the second data processing device.

2. The on-board optical connection device of claim 1, further comprising a load board, wherein the optical waveguide, the first signal transceiver, and the second signal transceiver are disposed on the load board.

3. The on-board optical connection device of claim 2, wherein the first signal transceiver comprises a signal input module comprising a bar substrate, a plurality of light emitters, and a plurality of first conductive components electrically connected between the signal input module and the first data processing device, wherein each of the light emitters is concurrently integrally arranged on the bar substrate and is configured to transmit the optical signal to the optical waveguide.

4. The on-board optical connection device of claim 3, wherein the bar substrate is configured to cross a bottom of each of the light emitters, the plurality of light emitters are adjustable in position in conjunction with the bar substrate, and the light emitters are concurrently optically aligned with the waveguide device through a one-time active alignment process.

5. The on-board optical connection device of claim 3, wherein the second signal transceiver comprises a signal output module comprising a supporting substrate, a plurality of light receptors arranged on the supporting substrate, and a plurality of second conductive components electrically connected between the signal output module and the second data processing device, wherein the light receptors receive the optical signal and convert the optical signal to the output electrical signal.

6. The on-board optical connection device of claim 5, wherein the optical waveguide comprises a waveguide substrate and a plurality of light paths disposed on the waveguide substrate, which is made of a material comprising silica, silicon, or silicon nitride.

7. The on-board optical connection device of claim 6, wherein the light paths of the optical waveguide are configured to define a planar lightwave circuit.

8. The on-board optical connection device of claim 6, wherein the waveguide substrate comprises a reflection structure located close to the signal output module and angularly disposed with respect to the light paths, and the optical signal transmitted from the signal input module is reflected by the reflection structure and strikes the signal output module.

9. The on-board optical connection device of claim 6, wherein the optical waveguide further comprises at least an optical isolator arranged across the light paths, and the optical isolator is configured to enable light transmission through the light paths in a desired direction to the signal output module.

10. The on-board optical connection device of claim 9, wherein the optical waveguide further comprises at least a slot and a plurality of light directing structures, the slot is arranged across the light paths, the light directing structures are located at opposite sides of the slot and adjoin the respective light paths, and the optical isolator is disposed in the slot and facing the light directing structures, wherein each of the light directing structures expands from the light path such that the light directing structure forms an aperture greater than a diameter of the light path.

11. An on-board optical connection device, connected between a first data processing device and a second data processing device, the on-board optical connection device comprising:
a load board;
an optical waveguide disposed on the load board and comprising a waveguide substrate and a plurality of light paths disposed on the waveguide substrate;
a first signal transceiver optically connected to the optical waveguide and disposed between the optical waveguide and the first data processing device on the load board; and
a second signal transceiver optically connected to the optical waveguide and disposed between the optical waveguide and the second data processing device on the load board;
wherein each of the first signal transceiver and the second signal transceiver defines a light input area and a light output area, and the two light input areas and the two light output areas cooperatively define a signal route.

12. The on-board optical connection device of claim 11, wherein the first signal transceiver and the second signal transceiver are connected to a first external power device and a second external power device, respectively.

13. The on-board optical connection device of claim 11, wherein the first signal transceiver comprises a plurality of light emitters disposed in the light input area of the first signal transceiver, and the second signal transceiver comprises a plurality of light emitters disposed in the light input area of the second signal transceiver, wherein the light emitters are arranged in optical alignment with the light paths, respectively.

14. The on-board optical connection device of claim 11, wherein the first signal transceiver comprises a plurality of optical channels disposed in the light output area of the first signal transceiver, and the second signal transceiver comprises a plurality of optical channels disposed in the light output area of the second signal transceiver, wherein the optical channels in the light output areas are in optical alignment with the light paths, respectively.

15. The on-board optical connection device of claim 11, wherein the optical waveguide further comprises at least an optical isolator arranged across the light paths, and the optical isolator is configured to enable light transmission through the light paths in a desired direction to the light output area.

16. The on-board optical connection device of claim 14, wherein the optical waveguide further comprises at least a slot and a plurality of light directing structures, the slot is arranged across the light paths, the light directing structures are located at opposite sides of the slot and adjoin the respective light paths, and the optical isolator is disposed in the slot and facing the light directing structures, wherein each of the light directing structures expands from the light path such that the light directing structure forms an aperture greater than a diameter of the light path.
